(19) United States
(12) Patent Application Publication
(10) Pub. No.: US 2026/0290976 A1
(43) Pub. Date: Sep. 24, 2026

(54) BATTERY PACK

(71) Applicant: TECHTRONIC CORDLESS GP, Anderson, SC (US)

(72) Inventors: Hei Man LEE, Hong Kong (CN); Jin Hui ZHOU, Dongguan City (CN); Dian Wu XU, Dongguan City (CN); Kui ZENG, Dongguan City (CN); Pei LIAO, Dongguan City (CN)

(21) Appl. No.: 19/474,361

(22) PCT Filed: Apr. 13, 2023
(86) PCT No.: PCT/CN2023/087986

§ 371 Date: Oct. 10, 2025

(51) Int. Cl. H01M 50/247; H01M 50/213; H01M 50/284; H01M 50/291; H01M 50/296; H01M 50/509; H01M 50/519

(52) U.S. Cl. CPC H01M 50/247; H01M 50/213; H01M 50/284; H01M 50/291; H01M 50/296; H01M 50/509; H01M 50/519; H01M 2220/30

(57) ABSTRACT

Embodiments provide a battery pack for a power tool. The battery pack includes a housing with at least one terminal configured to electrically connect the battery pack to the power tool. The battery pack also includes a battery cell support structure disposed within the housing. The battery cell support structure is configured to receive and support a plurality of battery cells. The battery pack further includes a circuit board for selectively providing power from the plurality of battery cells to the at least one terminal. Each of the plurality of battery cells has an alternating current internal resistance (ACIR) less than approximately 4 milliohms (mΩ). The battery pack has a battery pack energy density of at least approximately 100 watt-hours per liter (Wh/L).

### FIELD

Embodiments herein relate to battery packs.

### SUMMARY

Operation of power tools with high loads may be limited by the energy density of the battery pack powering the power tool. Additionally, power tools used in tight spaces may require more compact battery packs. High internal resistance in battery cells negatively affects current output of a battery pack.

Thus, one embodiment provide a battery pack for a power tool. The battery pack includes a housing with at least one terminal configured to electrically connect the battery pack to the power tool. The battery pack also includes a battery cell support structure disposed within the housing. The battery cell support structure is configured to receive and support a plurality of battery cells. The battery pack further includes a circuit board for selectively providing power from the plurality of battery cells to the at least one terminal. Each of the plurality of battery cells has an alternating current internal resistance (ACIR) less than approximately 4 milliohms (mΩ). The battery pack has a battery pack energy density of at least approximately 100 watt-hours per liter (Wh/L).

In one aspect, each of the plurality of battery cells has an AICR of approximately 3.05 mΩ.

In another aspect, each of the plurality of battery cells is a tabless cylindrical battery cell.

In another aspect, each of the plurality of battery cells has a battery cell nominal capacity of approximately 4 Ah.

In another aspect, the battery pack nominal capacity is 8 Ah, and the battery pack energy density is at least approximately 140.0 Wh/L.

In another aspect, the plurality of battery cells includes two sets of battery cells, each set of battery cells is connected in parallel, and each set of battery cells includes at least five battery cells connected in series.

In another aspect, the plurality of battery cells includes two sets of battery cells, each set of battery cells is connected in parallel, and each set of battery cells includes ten battery cells connected in series.

In another aspect, the battery pack nominal capacity is 12 Ah, and the battery pack energy density is at least approximately 200.0 Wh/L.

In another aspect, the plurality of battery cells includes three sets of battery cells, each set of battery cells is connected in parallel, and each set of battery cells includes ten battery cells connected in series.

In another aspect, each of the plurality of battery cells has a battery cell nominal capacity of approximately 3 Ah.

In another aspect, the battery pack nominal capacity is 6 Ah, and the battery pack energy density is at least approximately 130.0 Wh/L.

In another aspect, the plurality of battery cells includes two sets of battery cells, each set of battery cells is connected in parallel, and each set of battery cells includes ten battery cells connected in series.

In another aspect, the battery pack energy density is at least approximately 150.0 Wh/L.

In another aspect, the plurality of battery cells includes two sets of battery cells, each set of battery cells is connected in parallel, and each set of battery cells includes five battery cells connected in series.

In another aspect, the battery pack nominal capacity is 15 Ah, and the battery pack energy density is at least approximately 120.0 Wh/L.

In another aspect, the plurality of battery cells includes five sets of battery cells, each set of battery cells is connected in parallel, and each set of battery cells includes twenty battery cells connected in series.

In another aspect, the battery pack has a battery pack nominal capacity of at least approximately 4 Amp-hours (Ah).

### BRIEF DESCRIPTION OF THE DRAWINGS

FIG. 1 is a first example perspective view of a battery pack, according to some embodiments.

FIG. 2 is a second example perspective view of a battery pack, according to some embodiments FIG. 3 is a first example cross-sectional view of the battery pack of FIG. 1, according to some embodiments.

FIG. 4 is a second example cross-sectional view of the battery pack of FIG. 2, according to some embodiments.

FIG. 5A is a first example side view of the battery pack of FIG. 1, according to some embodiments.

FIG. 5B is a first example front view of the battery pack of FIG. 1, according to some embodiments.

FIG. 6A is a second example side view of a battery pack, according to some embodiments.

FIG. 6B is a second example front view of the battery pack of FIG. 6A, according to some embodiments.

FIG. 7A is a third example side view of a battery pack, according to some embodiments.

FIG. 7B is a third example front view of the battery pack of FIG. 7A, according to some embodiments.

FIG. 8A is a fourth example side view of a battery pack, according to some embodiments.

FIG. 8B is a fourth example front view of the battery pack of FIG. 8A, according to some embodiments.

FIG. 9A is a fifth example side view of a battery pack, according to some embodiments.

FIG. 9B is a fifth example front view of the battery pack of FIG. 8A, according to some embodiments.

FIG. 10A is a sixth example side view of a battery pack, according to some embodiments.

FIG. 10B is sixth example front view of the battery pack of FIG. 8A, according to some embodiments.

FIG. 11A is a seventh example side view of a battery pack, according to some embodiments.

FIG. 11B is a seventh example front view of the battery pack of FIG. 8A, according to some embodiments.

FIG. 12A is an eighth example side view of a battery pack, according to some embodiments.

FIG. 12B is an eighth example front view of the battery pack of FIG. 8A, according to some embodiments.

FIG. 13A is a ninth example side view of a battery pack, according to some embodiments.

FIG. 13B is a ninth example front view of the battery pack of FIG. 8A, according to some embodiments.

### DETAILED DESCRIPTION

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

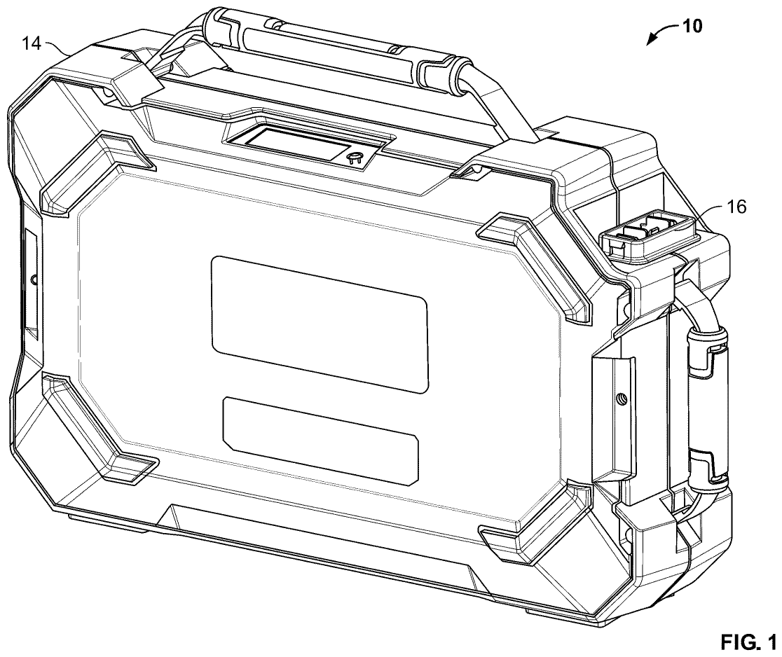

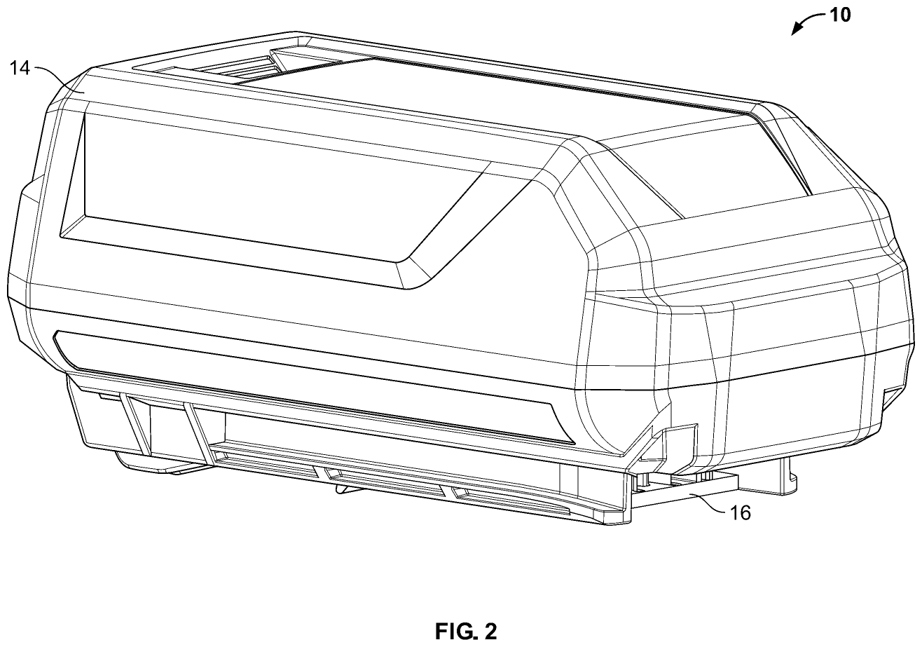

FIGS. 1-2 illustrate respective first and second example perspective views, in accordance with some embodiments, of a battery pack 10 including a battery pack housing 14 having at least one terminal 16 configured to electrically connect the battery pack 10 to an external device. In some embodiments, the battery pack 10 is configured to be a high power battery pack (e.g., having a nominal voltage of at least 80 volts (V)) connectable to and operable to power various motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, riding lawn mower etc.), other motorized devices (e.g., vehicles, utility carts, a material handling cart, etc.), and non-motorized electrical devices (e.g., a power source, a light, an AC/DC adapter, a generator, personal electronic device, etc.), any one of which may now be referred to herein as “device.” In some embodiments, the battery pack 10 has a nominal voltage of 40 V and is connectable to and operable to power various hand-held power tools (e.g., drills, fasteners, saws, pipe cutters, sanders, nailers, staplers, vacuum cleaners, etc.), as well as other electrical devices. In some embodiments, the battery pack 10 has a nominal voltage of 18 V and is connectable to and operable to power various hand-held power tools (e.g., drills, fasteners, saws, pipe cutters, sanders, nailers, staplers, vacuum cleaners, etc.), as well as other electrical devices.

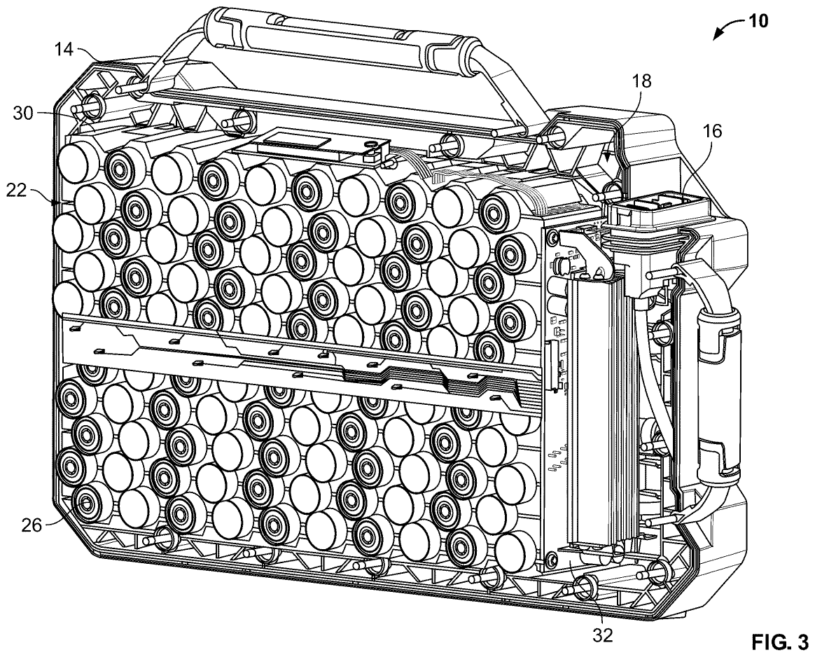

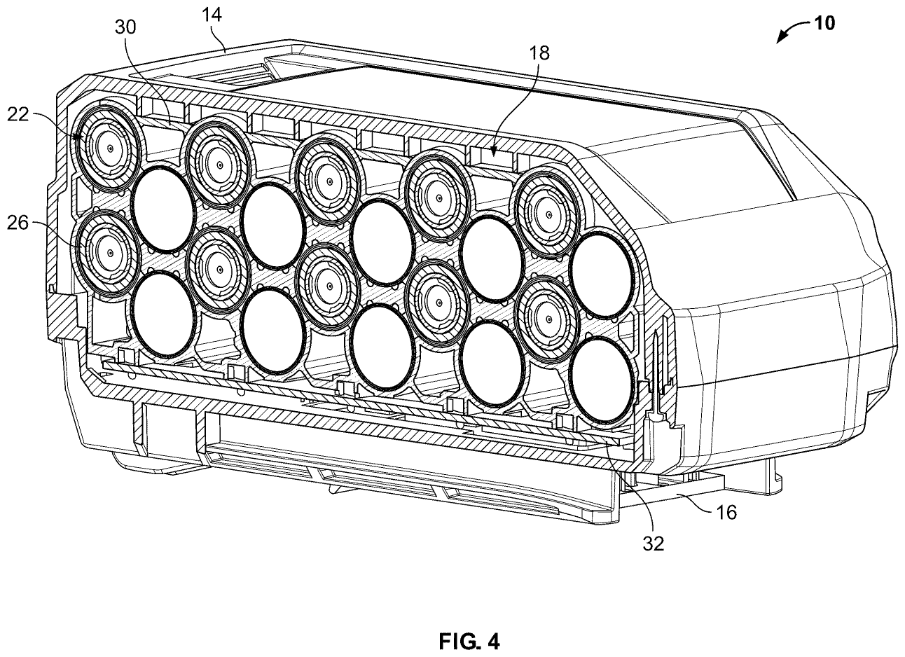

FIGS. 3-4 illustrate respective first and second example cross-sectional views of the battery pack 10 in accordance with some embodiments. As illustrated in FIGS. 3-4, the battery pack housing 14 includes an internal cavity 18 defined therewithin. A battery cell assembly 22 is positioned within the internal cavity 18. The battery cell assembly 22 includes a plurality of battery cells 26 and a support structure 30 configured to receive and support the plurality of battery cells 26 within the internal cavity 18. The battery pack housing 14 is shaped and sized to receive a predetermined number of battery cells 26 (e.g., ten battery cells, twenty battery cells, one-hundred battery cells, etc.). In some embodiments, the battery cell assembly 22 may include two or more battery cells 26. The battery cells 26 may be connected in series, parallel, or combination series-parallel to provide the desired electrical characteristics (e.g., nominal voltage, current output, current capacity, power capacity, etc.) of the battery pack 10. The battery pack housing 14 further includes a circuit board 32 for selectively providing power from the plurality of battery cells 26 to the at least one terminal. The circuit board 32 may provide operational control of the battery pack 10. For example, the circuit board 32 may control one or more electrical components within the battery pack 10 in order to control charge/discharge of the battery cells 26. The circuit board 32 may further receive one or more signals from various sensors. Such signals may be indicative of one or more characteristics of the battery pack and/or battery cells 26 (for example, but not limited to, a voltage of the battery cells 26, a current, and a temperature).

Each battery cell 26 may be a tabless cylindrical battery cell with a rolled arrangement (e.g., a jelly roll battery cell). Each battery cell 26 may have a battery cell volume defined by a diameter and a length. In some embodiments, each battery cell 26 has a volume of approximately 16,540 cubic millimeters (mm³) defined by a diameter between approximately 16 millimeters (mm) and approximately 20 mm (e.g., approximately 18 mm) and a length between approximately 63 mm and approximately 67 mm (e.g., approximately 65 mm). In other embodiments, each battery cell 26 has a volume of approximately 24,245 mm³ defined by a diameter between approximately 19 mm and approximately 23 mm (e.g., approximately 21 mm) and a length between approximately 68 mm and approximately 72 mm (e.g., approximately 70 mm). In other embodiments, each battery cell 26 may be tabbed cylindrical battery cell. Yet, in other embodiments, each battery cell 26 may be a pouch battery cell.

Each battery cell 26 may have a nominal voltage between about 3 V and about 5 V. For example, each battery cell 26 has a nominal voltage of 3.6 V. Each battery cell 26 may have a nominal capacity between about 2 Ah and about 6 Ah (in some cases, between about 3 Ah and about 5 Ah). For example, in some embodiments each battery cell 26 has a nominal capacity of 3 Ah, or approximately 11 Watt-hours (Wh). In some embodiments, each battery cell 26 has a nominal capacity of 4 Ah, or approximately 14 Wh. The battery cells 26 may be any rechargeable battery cell chemistry type, such as, for example, lithium (Li), lithium-ion (Li-ion), and/or other lithium-based chemistry.

Each battery cell 26 has a battery cell energy density defined by the nominal capacity and the volume. In some embodiments, each battery cell 26 has a battery cell energy density of at least 550 Watt-hours per liter (Wh/L). For example, a battery cell 26 according to some embodiments having a nominal capacity of approximately 11 Wh and a volume of approximately 16,540 mm³ may have a battery cell energy density between approximately 638 Wh/L and approximately 668 Wh/L (e.g., approximately 653 Wh/L). A battery cell 26 according to other embodiments having a nominal capacity of approximately 14 Wh and a volume of approximately 24245 mm³ may have a battery cell energy density between approximately 579 Wh/L and approximately 609 Wh/L (e.g., approximately 594 Wh/L).

In some embodiments, each of the battery cells 26 has a low internal resistance (IR), resulting in reduced temperature rises during operation of the battery pack 10 and higher energy retention. For example, each of the battery cells 26 may have an AC internal resistance (ACIR) less than 4 milliohms (mΩ) (e.g., approximately 3.05 mΩ). Because the low internal resistance in the battery cells 26 results in reduced operational temperatures, the battery pack 10 may be operable to deliver more energy to the device before a cutoff condition occurs (e.g., an overtemperature event, which is some embodiments results in the circuit 32 preventing discharge of the cells 26 when a sensed temperature crosses a threshold). Thus, for example, the battery pack 10 may power devices with high continuous loads (e.g., mowers, snowblowers, etc.) or high pulse-currents (e.g., chainsaws) for longer periods of time.

Additionally, with reduced operational temperatures, the battery cells 26 may be disposed closer to one another in the battery cell assembly 22. With a more compact battery cell assembly 22, the total volume of the battery pack 10 as defined by the battery pack housing 14 may be reduced, resulting in a higher overall energy density of the battery pack 10. A compact battery pack may then be used in tighter working spaces than a traditional battery pack. In some instances, the battery cell assembly 22 occupies between approximately 60% and approximately 90% of the volume of the internal cavity 18. In some instances, the battery cell assembly 22 occupies between approximately 70% and approximately 85% of the volume of the internal cavity 18.

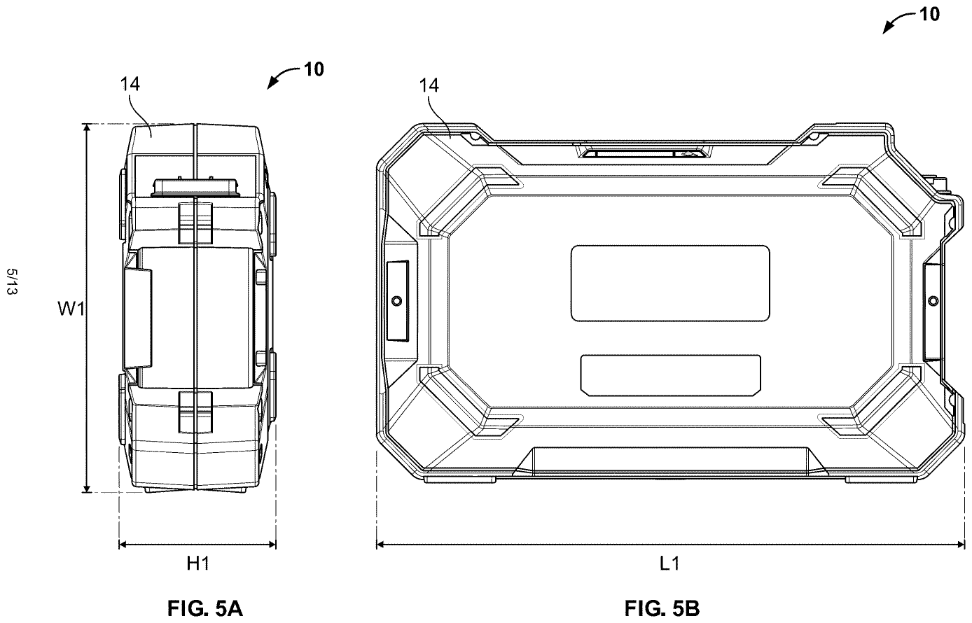

FIGS. 5A-5B illustrate a first example set of dimensions of the battery pack housing 14. The battery pack 10 has a battery pack volume defined by a housing length L1 between approximately 371.2 mm and approximately 391.2 mm (e.g., approximately 381.2 mm), a housing width W1 between approximately 223.2 mm and approximately 243.2 mm (e.g., approximately 233.2 mm), and a housing height H1 between approximately 89.6 mm and approximately 109.6 mm (e.g., approximately 98.6 mm), such that the battery pack volume is between approximately 7.36 liters and approximately 10.36 liters (e.g., approximately 8.77 liters).

Referring still to FIGS. 5A-5B, the battery pack housing 14 may be sized such that the plurality of battery cells 26 includes 100 battery cells. The plurality of battery cells 26 may include five sets of battery cells, each set of battery cells being connected in parallel. Each set of battery cells may include twenty battery cells connected in series. The battery pack 10 may have a nominal capacity of 15 Ah, or approximately 1080 Wh. Furthermore, the battery pack 10 may have a battery pack energy density of at least 100 Watt-hours per liter (Wh/L), defined by the ratio of battery pack capacity and the battery pack volume. In the illustrated example, the battery pack 10 may have a battery pack energy density between approximately 118.2 Wh/L and approximately 128.2 Wh/L (e.g., approximately 123.2 Wh/L).

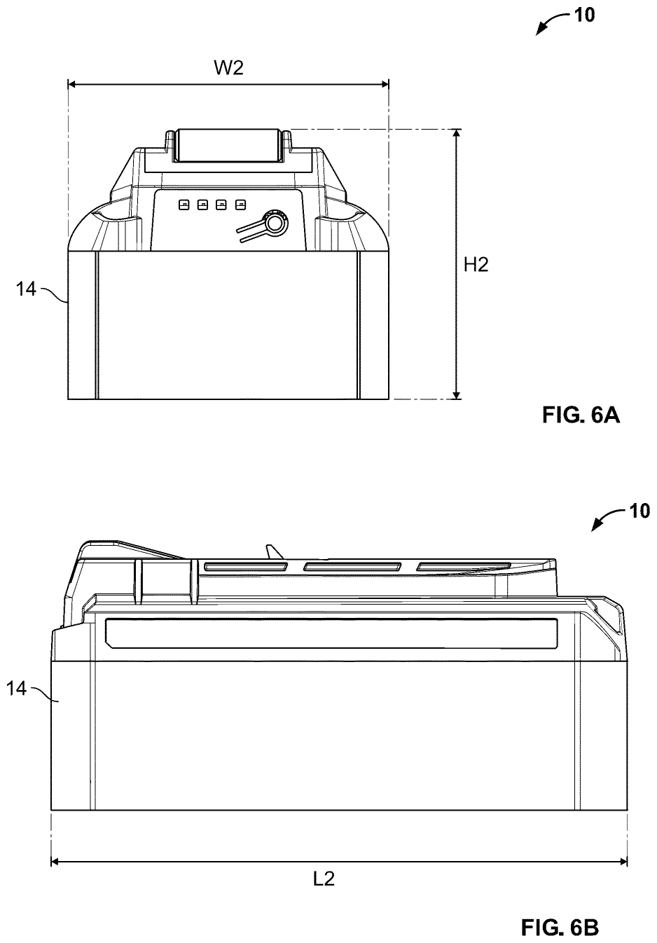

FIGS. 6A-6B illustrate a second example set of dimensions of the battery pack housing 14. In the illustrated example, the battery pack 10 has a battery pack volume defined by a housing length L2 between approximately 173.5 mm and approximately 193.5 mm (e.g., approximately 183.5 mm), a housing width W2 between approximately 90.4 mm and approximately 110.4 mm (e.g., approximately 100.4 mm), and a housing height H2 between approximately 76.0 mm and approximately 96.0 mm (e.g., approximately 86.6 mm), such that the battery pack volume is between approximately 1.19 liters and approximately 2.05 liters (e.g., approximately 1.58 liters).

Referring still to FIGS. 6A-6B, the battery pack housing 14 may be sized such that the plurality of battery cells 26 includes twenty battery cells. The plurality of battery cells 26 may include two sets of battery cells, each set of battery cells being connected in parallel. Each set of battery cells may include ten battery cells connected in series. The battery pack 10 may have a nominal capacity of 6 Ah, or approximately 216 Wh. The battery pack 10 may have a battery pack energy density of at least 130 Wh/L. For example, the battery pack 10 may have a battery pack energy density between approximately 131.7 Wh/L and approximately 141.7 Wh/L (e.g., approximately 136.7 Wh/L).

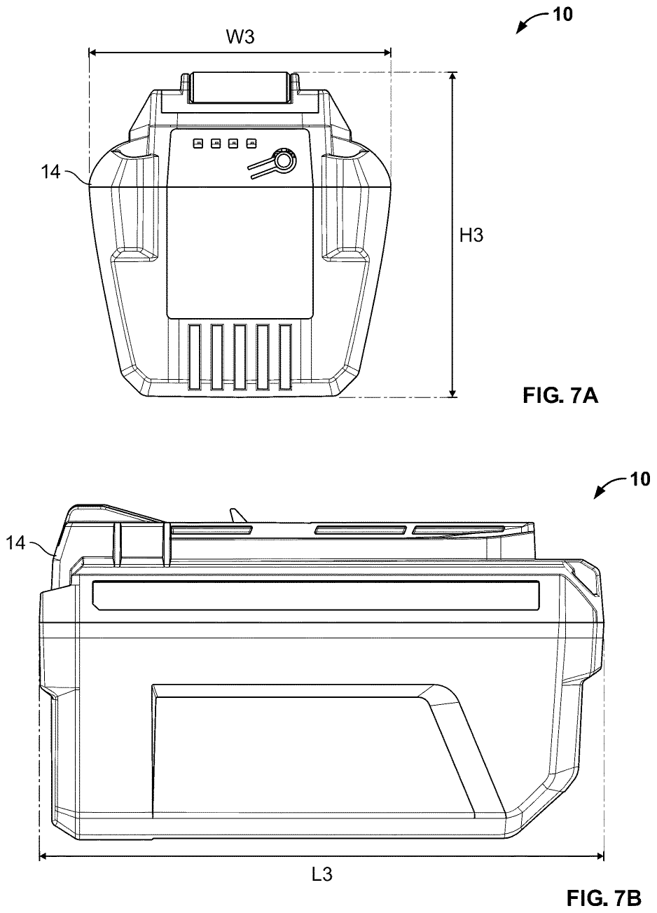

FIGS. 7A-7B illustrate a third example set of dimensions of the battery pack housing 14. In the illustrated example, the battery pack 10 has a battery pack volume defined by a housing length L3 between approximately 173.5 mm and approximately 193.5 mm (e.g., approximately 183.5 mm), a housing width W3 between approximately 90.4 mm and approximately 110.4 mm (e.g., approximately 100.4 mm), and a housing height H3 between approximately 98.2 mm and approximately 118.2 mm (e.g., approximately 108.2 mm), such that the battery pack volume is between approximately 1.79 liters and approximately 2.59 liters (e.g., approximately 1.99 liters).

Referring still to FIGS. 7A-7B, the battery pack housing 14 may be sized such that the plurality of battery cells 26 includes twenty battery cells. The plurality of battery cells 26 may include two sets of battery cells, each set of battery cells being connected in parallel. Each set of battery cells may include ten battery cells connected in series. The battery pack 10 may have a nominal capacity of 8 Ah, or approximately 288 Wh. The battery pack 10 may have a battery pack energy density of at least 135 Wh/L. For example, the battery pack 10 may have a battery pack energy density between approximately 139.5 Wh/L and approximately 149.5 Wh/L (e.g., approximately 144.5 Wh/L).

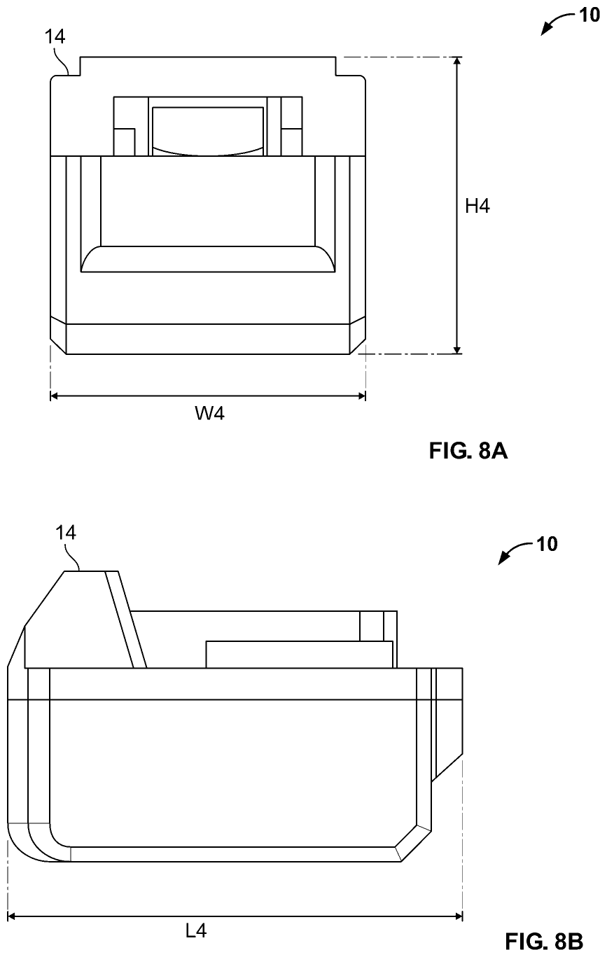

FIGS. 8A-8B illustrate a fourth example set of dimensions of the battery pack housing 14. In the illustrated example, the battery pack 10 has a battery pack volume defined by a housing length L4 between approximately 107.5 mm and approximately 127.5 mm (e.g., approximately 117.5 mm), a housing width W4 between approximately 65.0 mm and approximately 85.0 mm (e.g., approximately 75.0 mm), and a housing height H4 between approximately 69.0 mm and approximately 89.0 mm (e.g., approximately 79.0 mm), such that the battery pack volume is between approximately 0.63 liters and approximately 0.91 liters (e.g., approximately 0.70 liters).

Referring still to FIGS. 8A-8B, the battery pack housing 14 may be sized such that the plurality of battery cells 26 includes ten battery cells. The plurality of battery cells 26 may include two sets of battery cells, each set of battery cells being connected in parallel. Each set of battery cells may include five battery cells connected in series. The battery pack 10 may have a nominal capacity of 6 Ah, or approximately 108 Wh. The battery pack 10 may have a battery pack energy density of at least 150 Wh/L. For example, the battery pack 10 may have a battery pack energy density between approximately 150.2 Wh/L and approximately 160.2 Wh/L (e.g., approximately 155.2 Wh/L).

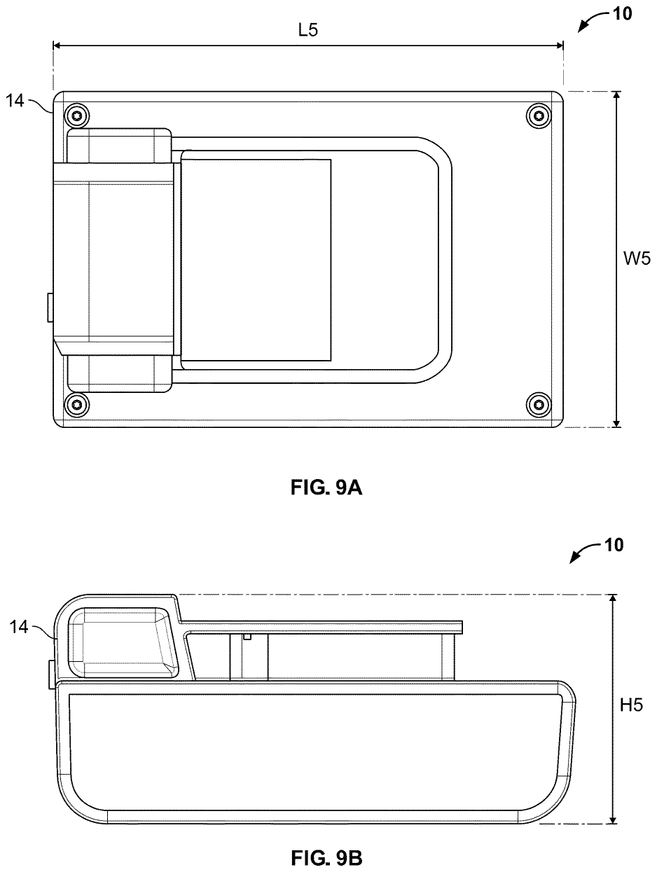

FIGS. 9A-9B illustrate a fifth example set of dimensions of the battery pack housing 14. In the illustrated example, the battery pack 10 has a battery pack volume defined by a housing length L5 between approximately 140.9 mm and approximately 160.9 mm (e.g., approximately 150.9 mm), a housing width W5 between approximately 74.5 mm and approximately 94.5 mm (e.g., approximately 84.5 mm), and a housing height H5 between approximately 46.4 mm and approximately 66.4 mm (e.g., approximately 56.4 mm), such that the battery pack volume is approximately 0.72 liters.

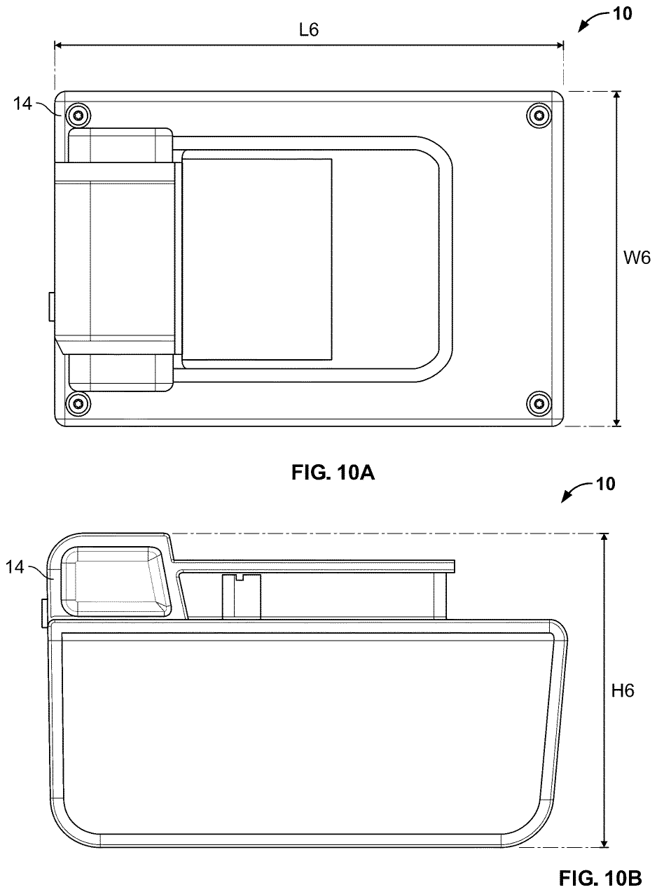

Referring still to FIGS. 9A-9B, the battery pack housing 14 may be sized such that the plurality of battery cells 26 includes five battery cells. The plurality of battery cells 26 may include one set of battery cells. Each set of battery cells may include five battery cells connected in series. The battery pack 10 may have a nominal capacity of 4 Ah, or approximately 72 Wh. The battery pack 10 may have a battery pack energy density of at least 100 Wh/L. For example, the battery pack 10 may have a battery pack energy density of approximately 100.1 Wh/L. FIGS. 10A-10B illustrate a sixth example set of dimensions of the battery pack housing 14. In the illustrated example, the battery pack 10 has a battery pack volume defined by a housing length L6 between approximately 140.9 mm and approximately 160.9 mm (e.g., approximately 150.9 mm), a housing width W6 between approximately 74.5 mm and approximately 94.5 mm (e.g., approximately 84.5 mm), and a housing height H6 between approximately 68.0 mm and approximately 88.0 mm (e.g., approximately 78.0 mm), such that the battery pack volume is approximately 1.11 liters.

Referring still to FIGS. 10A-10B, the battery pack housing 14 may be sized such that the plurality of battery cells 26 includes ten battery cells. The plurality of battery cells 26 may include two sets of battery cells, each set of battery cells being connected in parallel. Each set of battery cells may include five battery cells connected in series. The battery pack 10 may have a nominal capacity of 8 Ah, or approximately 144 Wh. The battery pack 10 may have a battery pack energy density of at least 140 Wh/L. For example, the battery pack 10 may have a battery pack energy density of approximately 144.8 Wh/L.

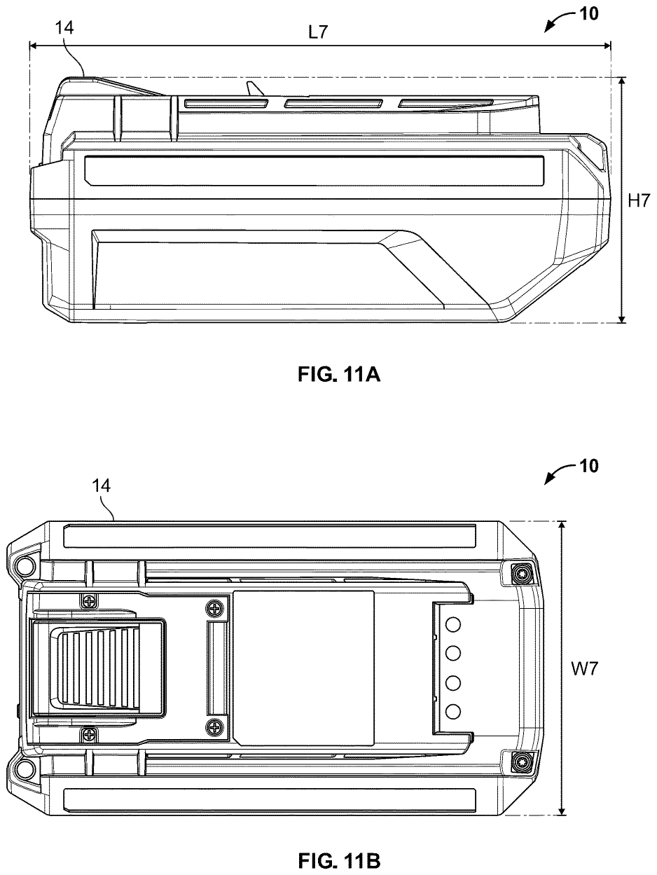

FIGS. 11A-11B illustrate a seventh example set of dimensions of the battery pack housing 14. In the illustrated example, the battery pack 10 has a battery pack volume defined by a housing length L7 between approximately 173.4 mm and approximately 193.4 mm (e.g., approximately 183.4 mm), a housing width W7 between approximately 90.4 mm and approximately 110.4 mm (e.g., approximately 100.4 mm), and a housing height H7 between approximately 67.0 mm and approximately 87.0 mm (e.g., approximately 77.0 mm), such that the battery pack volume is approximately 1.42 liters.

Referring still to FIGS. 11A-11B, the battery pack housing 14 may be sized such that the plurality of battery cells 26 includes ten battery cells. The plurality of battery cells 26 may include one set of battery cells. Each set of battery cells may include ten battery cells connected in series. The battery pack 10 may have a nominal capacity of 4 Ah, or approximately 144 Wh. The battery pack 10 may have a battery pack energy density of at least 100 Wh/L. For example, the battery pack 10 may have a battery pack energy density of approximately 100.1 Wh/L.

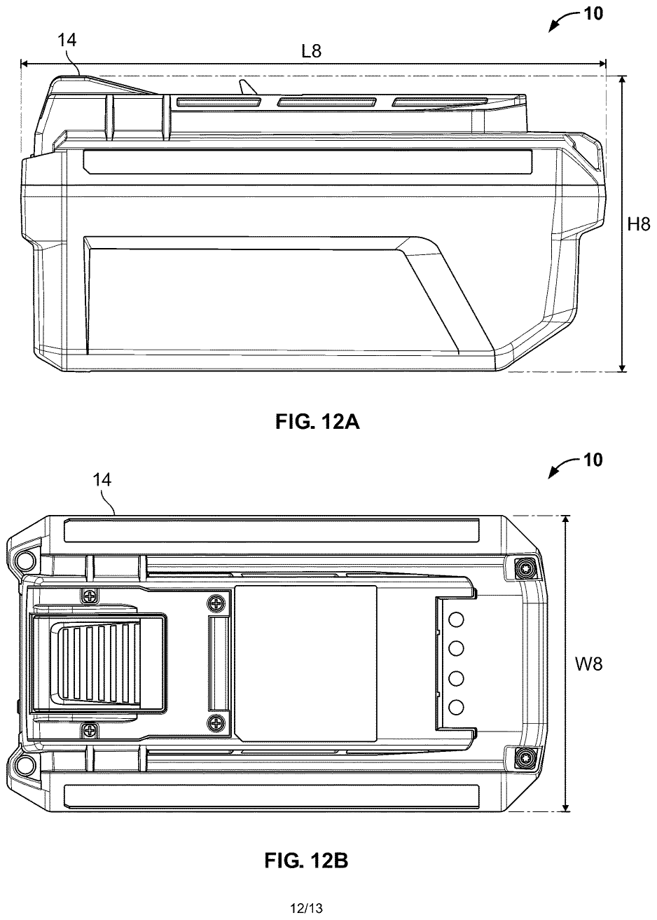

FIGS. 12A-12B illustrate an eighth example set of dimensions of the battery pack housing 14. In the illustrated example, the battery pack 10 has a battery pack volume defined by a housing length L8 between approximately 173.4 mm and approximately 193.4 mm (e.g., approximately 183.4 mm), a housing width W8 between approximately 90.4 mm and approximately 110.4 mm (e.g., approximately 100.4 mm), and a housing height H8 between approximately 98.0 mm and approximately 118.0 mm (e.g., approximately 108.0 mm), such that the battery pack volume is approximately 1.99 liters.

Referring still to FIGS. 12A-12B, the battery pack housing 14 may be sized such that the plurality of battery cells 26 includes twenty battery cells. The plurality of battery cells 26 may include two sets of battery cells. Each set of battery cells may be connected in parallel.

Each set of battery cells may include ten battery cells connected in series. The battery pack 10 may have a nominal capacity of 8 Ah, or approximately 288 Wh. The battery pack 10 may have a battery pack energy density of at least 140 Wh/L. For example, the battery pack 10 may have a battery pack energy density of approximately 144 Wh/L.

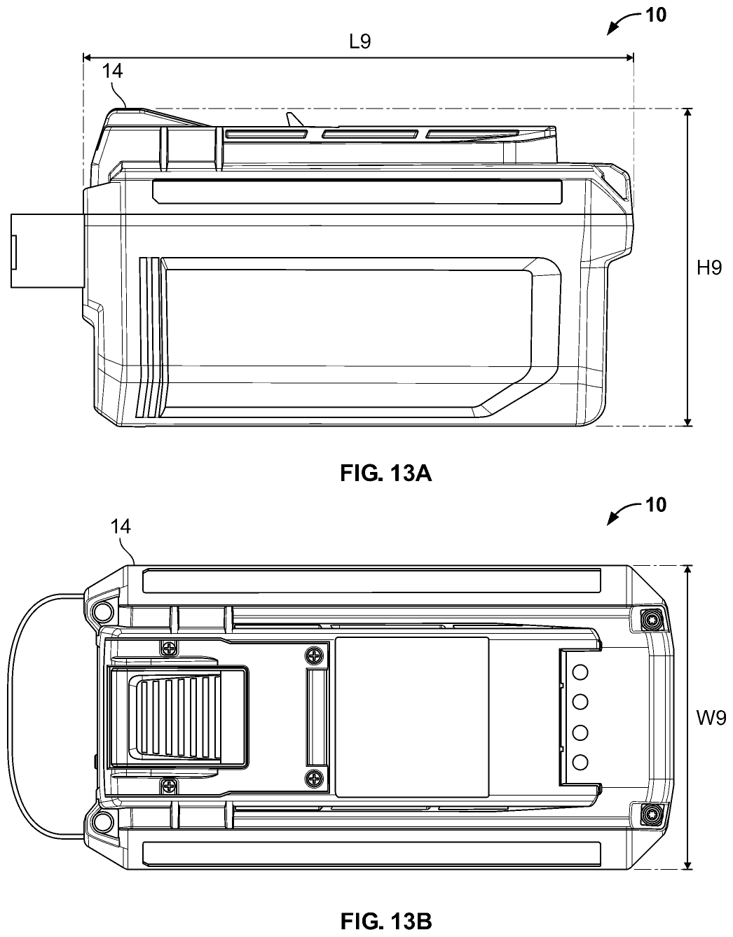

FIGS. 13A-13B illustrate a ninth example set of dimensions of the battery pack housing 14. In the illustrated example, the battery pack 10 has a battery pack volume defined by a housing length L9 between approximately 173.4 mm and approximately 193.4 mm (e.g., approximately 183.4 mm), a housing width W9 between approximately 90.4 mm and approximately 110.4 mm (e.g., approximately 100.4 mm), and a housing height H9 between approximately 107.0 mm and approximately 127.0 mm (e.g., approximately 117.0 mm), such that the battery pack volume is approximately 2.15 liters.

Referring still to FIGS. 13A-13B, the battery pack housing 14 may be sized such that the plurality of battery cells 26 includes thirty battery cells. The plurality of battery cells 26 may include three sets of battery cells. Each set of battery cells may be connected in parallel. Each set of battery cells may include ten battery cells connected in series. The battery pack 10 may have a nominal capacity of 12 Ah, or approximately 432 Wh. The battery pack 10 may have a battery pack energy density of at least 190 Wh/L. For example, the battery pack 10 may have a battery pack energy density of approximately 200.5 Wh/L.

Although aspects of the present disclosure have been described in detail with reference to certain embodiments, variations and modifications exist within the scope and spirit of one or more independent aspects as described. Various features of the disclosure are set forth in the following claims.

1. A battery pack for a power tool, the battery pack comprising:
a housing including at least one terminal configured to electrically connect the battery pack to the power tool;
a battery cell support structure disposed within the housing, the battery cell support structure configured to receive and support a plurality of battery cells;
a circuit board for selectively providing power from the plurality of battery cells to the at least one terminal;
wherein each of the plurality of battery cells has an alternating current internal resistance (ACIR) less than approximately 4 milliohms (mΩ), and
wherein the battery pack has a battery pack energy density of at least approximately 100 watt-hours per liter (Wh/L).

2. The battery pack of claim 1, wherein each of the plurality of battery cells has an AICR of approximately 3.05 mΩ.

3. The battery pack of claim 1, wherein each of the plurality of battery cells is a tabless cylindrical battery cell.

4. The battery pack of claim 3, wherein each of the plurality of battery cells has a battery cell nominal capacity of approximately 4 Ah.

5. The battery pack of claim 4, wherein the battery pack has a battery pack nominal capacity of approximately 8 Ah, and a battery pack energy density of at least approximately 140.0 Wh/L.

6. The battery pack of claim 5, wherein the plurality of battery cells includes two sets of battery cells, each set of battery cells is connected in parallel, and each set of battery cells includes at least five battery cells connected in series.

7. The battery pack of claim 5, wherein the plurality of battery cells includes two sets of battery cells, each set of battery cells is connected in parallel, and each set of battery cells includes ten battery cells connected in series.

8. The battery pack of claim 1, wherein the battery pack has a battery pack nominal capacity of approximately 12 Ah, and a battery pack energy density of at least approximately 200.0 Wh/L.

9. The battery pack of claim 8, wherein the plurality of battery cells includes three sets of battery cells, each set of battery cells is connected in parallel, and each set of battery cells includes ten battery cells connected in series.

10. The battery pack of claim 3, wherein each of the plurality of battery cells has a battery cell nominal capacity of approximately 3 Ah.

11. The battery pack of claim 10, wherein the battery pack has a battery pack nominal capacity is approximately 6 Ah, and a battery pack energy density of at least approximately 130.0 Wh/L.

12. The battery pack of claim 11, wherein the plurality of battery cells includes two sets of battery cells, each set of battery cells is connected in parallel, and each set of battery cells includes ten battery cells connected in series.

13. The battery pack of claim 10, wherein the battery pack has a battery pack energy density of at least approximately 150.0 Wh/L.

14. The battery pack of claim 13, wherein the plurality of battery cells includes two sets of battery cells, each set of battery cells is connected in parallel, and each set of battery cells includes five battery cells connected in series.

15. The battery pack of claim 10, wherein the battery pack has a battery pack nominal capacity is approximately 15 Ah, and a battery pack energy density of at least approximately 120.0 Wh/L.

16. The battery pack of claim 15, wherein the plurality of battery cells includes five sets of battery cells, each set of battery cells is connected in parallel, and each set of battery cells includes twenty battery cells connected in series.

17. The battery pack of claim 1, wherein the battery pack has a battery pack nominal capacity of at least approximately 4 Amp-hours (Ah).
